(19) United States
(12) Patent Application Publication
(10) Pub. No.: US 2002/0004704 A1
(43) Pub. Date: Jan. 10, 2002

(54) Portable GPS receiving device, navigation device and navigation system

(76) Inventors: Hideaki Nagatsuma, Chiba-shi (JP); Hiroshi Odagiri, Chiba-shi (JP); Kazumi Sakumoto, Chiba-shi (JP)

Correspondence Address: ADAMS & WILKS, 31st Floor, 50 Broadway, New York, NY, 10004, US

(21) Appl. No.: 09/888,775

(22) Filed: Jun. 25, 2001

(30) Foreign Application Priority Data
Jul. 6, 2000 (JP) 2000-210282

(51) Int. Cl. G01C 21/26

(52) U.S. Cl. 701/213; 342/357.13

(57) ABSTRACT

A portable GPS receiving device having a storage medium which is portable by a user and small in data storage capacity such as a wrist watch type GPS receiving device, the portable GPS receiving device includes: a navigation information acquiring portion mounted on a vehicle for use, such as an in-vehicle navigation device, for acquiring any one of map information on the surroundings of the present place of the portable GPS receiving device, destination information, sightseeing information, store information, walking information and other navigation information from a navigation device whose data storage capacity is larger than that of the storage medium, to store the acquired data in the storage medium.

### BACKGROUND OF THE INVENTION

1. Field of the Invention

The present invention relates to a portable GPS (Global Positioning System) receiving device that is portable by a user and relatively small in data storage capacity, such as a wrist watch type GPS receiving device, a navigation device that is mounted on a vehicle for use and relatively large in data storage capacity, such as an in-vehicle navigation device, and a navigation system including the portable GPS receiving device and the navigation device.

2. Description of the Related Art

As a conventional portable GPS receiving device, there have been known, for example, a small-sized portable GPS receiving device such as a wrist watch type GPS receiving device that is attached on a user' arm. In the portable type GPS receiving device of this type, a mass storage medium driving device such as a CD-ROM drive or a DVD drive cannot be mounted on the GPS receiving device due to the limit of the size of the portable GPS receiving device, and so on. Also, because a memory is small in capacity, wide-area map information cannot be stored in the GPS receiving device. Also, it is difficult to improve the operability due to the limit of the size of the portable GPS receiving device, which makes it difficult to set a destination or the like by directly operating the portable GPS receiving device.

Under the above circumstances, in general, in the case of using the portable GPS receiving device, the user previously inputs, to the GPS receiving device, map information on the surroundings of a place where the GPS receiving device is used, destination information, and other navigation information from a personal computer (PC) located in a house before leaving home. For example, in the case where the user goes to a mountain by an automobile for hiking or picnic or in the case where the user goes to a strange town, the user inputs the navigation information on the surroundings of a place where the user will go to the portable GPS receiving device from a PC or the like located in the house before leaving home, and travels to that place by the automobile. Then, the user gets off the automobile while putting on the portable GPS receiving device and walks around that place.

However, in the above conventional technique, the user must inputs the navigation information on the surroundings of the place where the user will go to the portable GPS receiving device from the PC or the like which is located in the house before leaving from home by a vehicle such as an automobile, and in the case where the user changes the destination because a parking is full or a traffic accident occurs, in the case where the user does not decide the destination in advance, or in the case where the user fails to input the navigation information, because the navigation information on the surroundings of the place to which the user has actually gone is not inputted to the portable GPS receiving device, there arises such a problem in that the portable GPS receiving device cannot be effectively used.

### SUMMARY OF THE INVENTION

The present invention has been made in view of the above circumstances, and therefore an object of the present invention is to provide a portable GPS receiving device which can be effectively used even if the navigation information on the surroundings of a place where the user has actually gone by a vehicle is not inputted to the portable GPS receiving device in advance.

In order to achieve the above object, according to the present invention, there is provided a navigation system including one or more portable GPS receiving devices which are portable by a user and small in data storage capacity, such as a wrist watch type GPS receiving device and a navigation device which is mounted on a vehicle for use and larger in data storage capacity than the portable GPS receiving device, such as an in-vehicle navigation device, the navigation device including a navigation information transmitting means for selecting the navigation information on the surroundings of a present place at which the portable GPS receiving device exists from a storing means for storing map information, destination information, sightseeing information, store information, walking information and other navigation information to transmit the selected navigation information, and the portable GPS receiving device includes a navigation information acquiring means for acquiring the transmitted navigation information to store the data in a storage medium.

In other words, in the navigation system, any one of the map information on the surroundings of the present place of the portable GPS receiving device, the destination information, the sightseeing information, the store information, the walking information and other navigation information is transmitted to the portable GPS receiving device from the navigation device in a wire or radio manner. As a result, even if the navigation information on a scheduled place is not previously inputted to the portable GPS receiving device before leaving home by the vehicle such an automobile, the navigation information on the surroundings of a place at which the user has actually gone can be simply and surely inputted to the portable GPS receiving device at the place where the user has actually gone.

Also, the portable GPS receiving device may include a present place information radio transmitting means for transmitting the present place information of the portable GPS receiving device to the navigation device in a radio manner, and a navigation information radio acquiring means for acquiring the navigation information from the navigation device in a radio manner, and the navigation device may include a present place information radio acquiring means for acquiring the present place information from the portable GPS receiving device in the radio manner, and a navigation information radio transmitting means for selecting the navigation information of the surroundings of the present place on the basis of the present place information from the storing means for storing the navigation information to transmit the selected navigation information to the portable GPS receiving device in the radio manner.

According to the navigation system, the present place information radio transmitting means of the portable GPS receiving device transmits the present place information of the portable GPS receiving device to the navigation device in a radio manner, and the present place information radio acquiring means of the navigation device acquires the present place information. Also, the navigation information radio transmitting means selects the navigation information of the surroundings of the present place on the basis of the present place information from the storing means for storing the navigation information to transmit the selected navigation information in the radio manner, and the navigation information radio acquiring means of the portable GPS receiving device acquires the navigation information. As a result, the navigation information on the surroundings of the present place can be appropriately inputted to the portable GPS receiving device with the travel of the user if the radio electric waves reach the portable GPS receiving device.

Also, the portable GPS receiving device may include a position information storing means for storing position information therein, and a position information transmitting means for transmitting the position information stored in the position information storing means to the navigation device, and the navigation device may include a position information acquiring means that acquires the position information. In this navigation system, the position information storing means of the portable GPS receiving device stores the position information therein, the position information transmitting means transmits the position information, and the position information receiving means of the navigation device acquires the position information. As a result, for example, it is possible that the position information on a good restaurant, a beauty spot, a walking locus or the like which is found while the user walks is recorded, and the position information is transmitted to the navigation device from the portable GPS receiving device in the radio or wire manner.

Further, the portable GPS receiving device may include an address retrieving means for retrieving an address on the basis of measured longitude and latitude, an arrow indicating means for indicating a direction of the destination by an arrow, and a voice guide means for guiding the direction of the destination or a route to the destination by a voice. With this structure, even in the case where a display screen is small with the limit of the size of the portable GPS receiving device or the like to make it difficult to view the map indication or to make it impossible to indicate the map, an understandable navigation or position indication can be conducted.

In addition, the navigation device may include a navigation information supplementing means for supplementing additional navigation information through a radio telephone line. Since the navigation information supplementing means supplements the navigation information, sufficient information can be inputted to the portable GPS receiving device.

### BRIEF DESCRIPTION OF THE DRAWINGS

These and other objects and advantages of the present invention will become more fully apparent from the following detailed description taken with the accompanying drawings in which:

FIG. 1 is a diagram showing the rough structure of a navigation system in accordance with an embodiment of the present invention;

FIG. 2 is a diagram showing a hardware structure of a portable GPS receiving device in accordance with the embodiment;

FIG. 3 is a diagram showing a hardware structure of a navigation device in accordance with the embodiment;

FIG. 4 is a diagram showing the functional structure of the portable GPS receiving device in accordance with the embodiment;

FIG. 5 is a diagram showing the functional structure of the navigation device in accordance with the embodiment;

FIG. 6 is a flowchart showing a flow of a navigation information transmitting process (short distance) from the navigation device to the portable GPS receiving device in accordance with the embodiment;

FIG. 7 is a flowchart showing a flow of a navigation process of the portable GPS receiving device in accordance with the embodiment;

FIG. 8 is a flowchart showing a flow of a navigation information transmitting process (long distance) from the navigation device to the portable GPS receiving device in accordance with the embodiment;

FIG. 9 is an explanatory diagram for explaining another navigation process of the portable GPS receiving device in accordance with the embodiment;

FIG. 10 is an explanatory diagram for explaining an address indicating process of the portable GPS receiving device in accordance with the embodiment;

FIG. 11 is a flowchart showing a flow of the address indicating process of the portable GPS receiving device in accordance with the embodiment; and

FIG. 12 is a flowchart showing a flow of a navigation information supplementing process through a radio telephone line of the navigation device in accordance with the embodiment.

### DETAILED DESCRIPTION OF THE PREFERRED EMBODIMENTS

Now, a description will be given in more detail of preferred embodiments of the present invention with reference to the accompanying drawings.

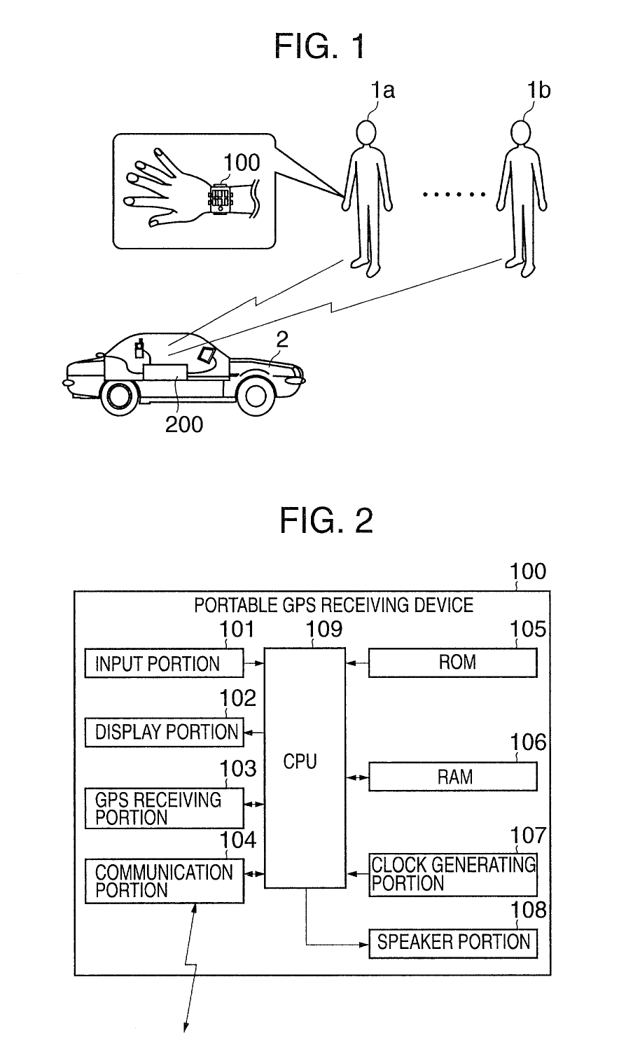

It should be noted that the present invention is not limited by the following embodiments. First, the structure of a navigation system in accordance with this embodiment will be described. FIG. 1 is a diagram showing the rough structure of a navigation system in accordance with an embodiment of the present invention.

In FIG. 1, the navigation system includes one or more portable GPS receiving device 100 which is portable by a user and relatively small in data storage capacity, and a navigation device 200 which is mounted on a vehicle such as an automobile for use and relatively large in data storage capacity. The portable GPS receiving device 100 cannot store wide-area navigation information therein because the GPS receiving device 100 has no mass storage medium driving device such as a CD-ROM or a DVD, and has a small capacity of memory such as a ROM or RAM. However, since the device 100 is small in size, the device 100 can be carried for use by the user with ease. The portable GPS receiving device 100 may include, for example, a wrist watch type GPS receiving device attached onto arms of users 1a to 1b, a PDA type GPS receiving device and a pendant type GPS receiving device.

On the other hand, the navigation device 200 is mounted on a vehicle such as an automobile 2 for use (the device 200 may be fixed to the vehicle or brought out from the vehicle for use), and has the mass storage medium driving device such as a CD-ROM or a DVD so as to provide the wide-area navigation information. However, the navigation device 200 cannot be brought out from the vehicle and carried by the user with ease. The navigation device 200 may include, for example, a car navigation system and a motorbike navigation device.

The portable GPS receiving device 100 and the navigation device 200 transmit and receive data such as navigation information, present place information or position information each other in a wired manner or a radio manner. In this specification, the navigation information may include map information, destination information, sightseeing information, store information, walking information and the like. Also, the present place information is information on a point at which the portable GPS receiving device 100 is positioned at present, which is represented by latitude, longitude, altitude and the like. Further, the position information is information on the travel locus of the user (the travel locus of the portable GPS receiving device 100) and a point recorded by the user.

(Hardware Structure of Portable GPS Receiving Device)

Subsequently, the hardware structure of the portable GPS receiving device 100 will be described. FIG. 2 is a diagram showing the hardware structure of the portable GPS receiving device 100 in accordance with this embodiment. The portable GPS receiving device 100 includes an input portion 101, a display portion 102, a GPS receiving portion 103, a communication portion 104, an ROM 105, a RAM 106, a clock generating portion 107, a speaker portion 108 and a CPU 109. The ROM 105 stores control program for controlling the respective portions of the portable GPS receiving device 100 therein. The CPU 109 controls the respective portions of the portable GPS receiving device 100 in accordance with the control program stored in the ROM 105. The RAM 106 is used as operation area of the CPU 109, and the like.

The input portion 101 includes an input device such as an input button or an aqu point, and inputs a command from the user and transmits the command to the CPU 109. The display portion 102 includes a display such as a liquid crystal display or an organic EL display, and displays a map, and the like, under the control of the CPU 109. The GPS receiving portion 103 includes a GPS antenna and a GPS receiver, produces present place information, speed information, time information, and the like, and outputs the information to the CPU 109 as data. The communication portion 104 transmits and receives data of the navigation information, the present place information, the position information, and the like, with the navigation device 200. The clock generating portion 107 produces a clock signal to output the signal to the CPU 109. The speaker portion 108 includes a speaker and outputs a voice under the control of the CPU 109.

(Hardware Structure of Navigation Device)

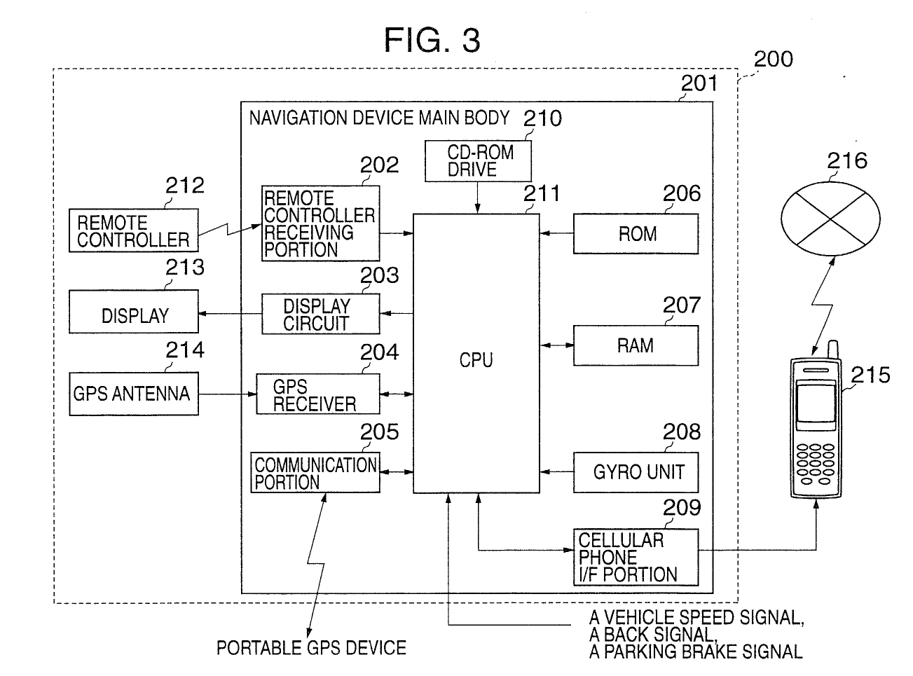

FIG. 3 is a diagram showing the hardware structure of the navigation device 200 shown in FIG. 1 in accordance with this embodiment. The navigation device 200 includes a navigation device main body 201, a remote controller 212, a display 213 and a GPS antenna 214. The navigation device main body 201 includes a remote controller receiving portion 202, a display circuit 203, a GPS receiver 204, a communication portion 205, a ROM 206, a RAM 207, a gyro unit 208, a cellular phone interface portion (cellular phone I/F portion) 209, a CD-ROM drive 210 and a CPU 211.

The ROM 206 stores control program for controlling the respective portions of the navigation device 200, and the like. The CPU 211 controls the respective portions of the navigation device 200 in accordance with the control program stored in the ROM 206. The RAM 207 is used as the operation area of the CPU 211, and the like. The remote controller receiving portion 202 receives a signal from the remote controller 212 and transmits a command from the user to the CPU 211. The display circuit 203 outputs an image signal to the display 213 under the control of the CPU 211 and displays the map and the like. The GPS receiver 204 produces the present place information, the speed information, the time information, and the like, on the basis of a signal from the GPS antenna 214, and outputs the information to the CPU 211 as data.

The communication portion 205 transmits and receives the data of the navigation information, the present place information, the position information, and the like with the portable GPS device 100. The gyro unit 208 detects a change in the traveling direction of the automobile 2 (a change in the traveling direction of the navigation device 200) to output the data of the detected result to the CPU 211. The cellular phone I/F portion 209 is connectable to a cellular phone mobile device 215 through a cable or the like, and inputs various information through a public line 216 and the cellular phone mobile device 215 to transmit the information to the CPU 211. The information is additional navigation information such as various communication services of information supplied from a cellular phone communication company, or the like. The system of the cellular phone is not particularly restricted.

The CD-ROM drive 210 drives the CD-ROM that stores the navigation information therein under the control of the CPU 211 and reads the navigation information from the CD-ROM to appropriately output the information to the CPU 211. The CD-ROM and the CD-ROM drive 210 may be replaced by another storage medium such as a DVD or a DVD drive, or a mass semiconductor memory (the memory may be fixed onto the navigation device 200 or detachably mounted on the navigation device 200 as a PC card). Also, the navigation device main body 201 inputs a vehicle speed signal and a back signal from the automobile 2 to improve a precision in the measurement and also inputs a parking brake signal to improve the safety. Since the remote controller 212, the display 213, the GPS antenna 214 and the cellular phone mobile device 215 are well known by an ordinary skilled person, descriptions thereof will be omitted.

(Functional Structure of Portable GPS Receiving Device)

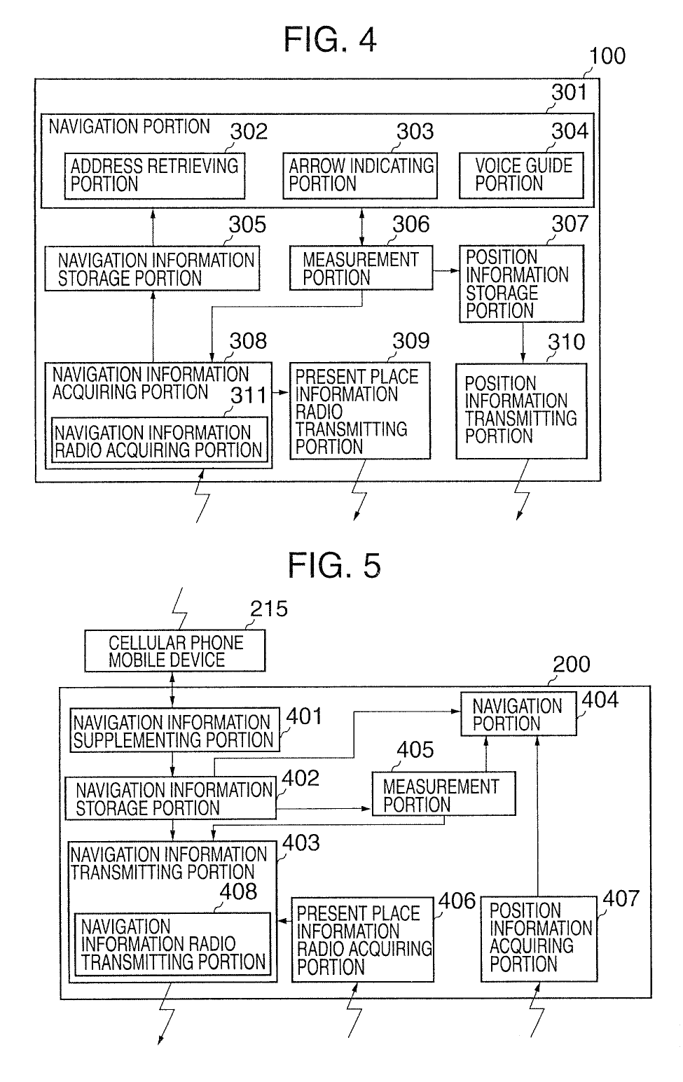

FIG. 4 is a diagram showing the functional structure of the portable GPS receiving device 100 in accordance with this embodiment. The portable GPS receiving device 100 includes a navigation portion 301, a navigation information storage portion 305, a measurement portion 306, a position information storage portion 307, a navigation information acquiring portion 308, a present place information radio transmitting portion 309, a position information transmitting portion 310 and a navigation information radio acquiring portion 311.

The navigation portion 301 includes an address retrieving portion 302, an arrow indicating portion 303 and a voice guide portion 304. The navigation portion 301 inputs the navigation information from the navigation information storage portion 305 and the measurement information (the present place information) from the measurement portion 306 to display a map around the present place and a time, or to conduct a voice guide by means of a speaker. Also, the navigation portion 301 switches the display in accordance with a command from the user. The navigation portion 301 is realized by the CPU 109, the ROM 105, the RAM 106, the input portion 101, the display portion 102, the clock generating portion 107 and the speaker portion 108 shown in FIG. 2.

The address retrieving portion 302 retrieves an address of the present place from the navigation information storage portion 305 on the basis of the present place information from the measurement portion 306 and displays the retrieved address on the display. The address retrieving portion 302 is realized by the CPU 109, the ROM 105, the RAM 106 and the display portion 102 shown in FIG. 2. The arrow indicating portion 303 indicates an arrow indicative of a direction of the destination on the display on the basis of the destination information from the navigation information storage portion 305 and the present place information from the measurement portion 306. The arrow may be indicated together with the map or may be indicated instead of the map. Also, in the case where it is difficult to display the map because a display screen is small, only the arrow may be indicated. The arrow indicating portion 303 is realized by the CPU 109, the ROM 105, the RAM 106 and the display portion 102 shown in FIG. 2.

The voice guide portion 304 guides the direction of the destination or a route to the destination with a voice from a speaker on the basis of the destination information from the navigation information storage portion 305 and the present place information from the measurement portion 306. The voice guide portion 304 is realized by the CPU 109, the ROM 105, the RAM 106 and the speaker portion 108 shown in FIG. 2. The navigation information storage portion 305 inputs the navigation information from the navigation information acquiring portion 308 and sets and updates the navigation information to be stored to appropriately output the navigation information to the navigation portion 301. The navigation information storage portion 305 is realized by the RAM 106 shown in FIG. 2 and a peripheral circuit.

The measurement portion 306 receives GPS electric waves and produces the present place information, the speed information, the time information, and the like, to output those information to the navigation portion 301, the position information storage portion 307 and the navigation information acquiring portion 308. The measurement portion 306 is realized by the GPS receiving portion 103 shown in FIG. 2. The position information storage portion 307 stores the position information therein. Specifically, the position information storage portion 307 inputs the present place information from the measurement portion 306 to store the information on the travel locus, or stores the present place at the time of receiving a command from the user if the storage portion 307 receives the command. Also, the position information storage portion 307 can display the stored position information and edit the position information in accordance with the command from the user or transmit the position information to the navigation device 200 through the position information transmitting portion 310. The position information storage portion 307 is realized by the CPU 109, the ROM 105, the RAM 106, the display portion 102 and the input portion 101 shown in FIG. 2.

The navigation information acquiring portion 308 acquires the navigation information on the surroundings of the portable GPS receiving device 100 from the navigation device 200 through a wire or a radio at a short distance (a distance as short as the position of the portable GPS receiving device 100 and the position of the navigation device 200 can be identical with each other), and outputs the navigation information to the navigation information storage portion 305. The communication system is not particularly restricted, and may be serial communication or parallel communication in case of the wire. Further, in case of the radio, a weak electric wave or an infrared ray may be employed.

Also, the navigation information acquiring portion 308 includes the navigation information radio acquiring portion 311. The navigation information radio acquiring portion 311 inputs the present place information from the measurement portion 306. Then, the navigation information acquiring portion 308 instructs the present place information radio transmitting portion 309 to transmit the present place information to the navigation device 200 in accordance with an area (geographic area) of the navigation information (the navigation information finally acquired) stored in the navigation information storage portion 305 and the present place. Then, the navigation information acquiring portion 308 acquires the navigation information on the surroundings of the present place of the portable GPS receiving device 100 from the navigation device 200 through a radio. The navigation information acquiring portion 308 and the navigation information radio acquiring portion 311 are realized by the CPU 109, the ROM 105, the RAM 106 and the communication portion 104 shown in FIG. 2. Even in the case of acquiring the navigation information at a short distance, the navigation information radio acquiring portion 311 may be used.

The present place information radio transmitting portion 309 transmits the present place information of the portable GPS receiving device 100 to the navigation device 200 in accordance with a command from the navigation information radio acquiring portion 311 through a radio. The present place information radio transmitting portion 309 is realized by the communication portion 104 shown in FIG. 2. The position information transmitting portion 310 transmits the position information from the position information storage portion 307 to the navigation device 200 through the wire or the radio. The position information transmitting portion 310 is realized by the communication portion 104 shown in FIG. 2. The communication system of the present place information radio transmitting portion 309 and the position information transmitting portion 310 is not particularly restricted as in the navigation information acquiring portion 308 and the navigation information radio acquiring portion 311.

(Functional Structure of Navigation Device)

FIG. 5 is a diagram showing the functional structure of the navigation device 200 in accordance with this embodiment in FIG. 1. The navigation device 200 includes a navigation information supplementing portion 401, a navigation information storage portion 402, a navigation information transmitting portion 403, a navigation portion 404, a measurement portion 405, a present place information radio acquiring portion 406, a position information acquiring portion 407 and a navigation information radio transmitting portion 408.

The navigation information supplementing portion 401 is connectable to the cellular phone mobile device 215 and connected to the public line 216 through the cellular phone mobile device 215. Also, the navigation information supplementing portion 401 inputs additional navigation information other than the navigation information stored in the CD-ROM and outputs the inputted data to the navigation information storage portion 402. The navigation information supplementing portion 401 is realized by the CPU 211, the ROM 206, the RAM 207 and the cellular phone I/F portion 209 shown in FIG. 3.

The navigation information storage portion 402 reads the navigation information from the CD-ROM and also stores the additional navigation information from the navigation information supplementing portion 401 in the RAM 207. Also, the navigation information storage portion 402 displays the destination setting screen, sets a destination in accordance with the manipulation by the user, and stores the destination information in the RAM 207. Then, the navigation information storage portion 402 appropriately outputs the navigation information to the measurement portion 405, the navigation information transmitting portion 403 and the navigation portion 404. The navigation information storage portion 402 is realized by the CPU 211, the ROM 206, the RAM 207, the CD-ROM drive 210, the remote controller 212, the remote controller receiving portion 202, the display 213 and the display circuit 203 shown in FIG. 3.

The navigation information transmitting portion 403 inputs the present place information (the present place information of the navigation device 200) from the measurement portion 405 and inputs the navigation information on the surroundings of the present place from the navigation information storage portion 402. Then, the navigation information transmitting portion 403 transmits the navigation information to the portable GPS receiving device 100 at a short distance of the degree that the position of the portable GPS receiving device 100 and the position of the navigation device 200 can be identical with each other through the wire or the radio. In other words, the navigation information transmitting portion 403 transmits the navigation information of the navigation device 200 to the portable GPS receiving device 100 with the present place of the navigation device 200 as the present place of the portable GPS receiving device 100 at a short distance. The transmission of the navigation information is conducted when receiving the command from the user through the remote controller 212.

For example, when the automobile is stopped at a parking, the present place of the navigation device 200 is measured, and the navigation information on the surroundings of the present place is read to a high-speed storage medium such as a RAM from a low-speed storage medium such as a CD-ROM. Therefore, the navigation information on the surroundings of the present place of the navigation device 200 can be simply and rapidly transmitted to the portable GPS receiving device 100.

Also, the navigation information transmitting portion 403 has the navigation information radio transmitting portion 408. The navigation information radio transmitting portion 408 inputs the present place information (the present place information of the portable GPS receiving device 100) from the present place information radio acquiring portion 406, and also inputs the navigation information on the surroundings of the present place from the navigation information storage portion 402 to transmit the navigation information to the portable GPS receiving device 100 through the radio. The navigation information transmitting portion 403 and the navigation information radio transmitting portion 408 are realized by the CPU 211, the ROM 206, the RAM 207, the remote controller 212, the remote controller receiving portion 202 and the communication portion 205 shown in FIG. 3. Similarly, in the case of transmitting the navigation information at the short distance, the navigation information radio transmitting portion 408 may be used.

The navigation portion 404 inputs the present place information from the measurement portion 405 and inputs the navigation information on the surroundings of the present place from the navigation information storage portion 402 to display the map or the like for guiding a road. Also, the navigation portion 404 inputs the position information from the position information acquiring portion 407 (position information from the portable GPS receiving device 100) so as to display the walking locus of the user and a point recorded by the user on the map. Further, the map display manner can be switched in accordance with the command from the user such that the map is scrolled or changed to a birds-eye view or a plan view. The navigation portion 404 is realized by the CPU 211, the ROM 206, the RAM 207, the remote controller 212, the remote controller receiving portion 202, the display 213 and the display circuit 203 shown in FIG. 3.

The measurement portion 405 presumes the present place of the navigation device 200 from the GPS information from a GPS satellite, a vehicle speed signal and a back signal from the automobile 2, a signal from the gyro unit 208, the road information from the navigation information storage portion 402 and the like and produces the present place information to output the present place information to the navigation portion 404 and the navigation information transmitting portion 403. The measurement portion 405 is realized by the CPU 211, the ROM 206, the RAM 207, the GPS antenna 214, the GPS receiver 204 and the gyro unit 208 shown in FIG. 3.

The present place information radio acquiring portion 406 acquires the present place information from the portable GPS receiving device 100 through the radio and outputs the data to the navigation information transmitting portion 403. The present place information radio acquiring portion 406 conducts the operation of waiting the present place information from the portable GPS receiving device 100 after the user gets off the automobile 2 at the parking. That is, a power must be supplied to the navigation device 200 even after the user gets off the automobile 2. To achieve this, for example, a primary battery or a secondary battery may be located at the navigation device 200, or the power may be always supplied to the navigation device 200 from a battery of the automobile 2. The present place information radio acquiring portion 406 is realized by the communication portion 205 shown in FIG. 3.

The position information acquiring portion 407 acquires the position information from the portable GPS receiving device 100 through the radio or the wire and outputs the data to the navigation portion 404. The position information acquiring portion 407 is realized by the communication portion 205 shown in FIG. 3. The navigation information transmitting portion 403, the navigation information radio transmitting portion 408, the present place information radio acquiring portion 406 and the position acquiring portion 407 correspond to the navigation information acquiring portion 308, the navigation information radio acquiring portion 311, the present place information radio transmitting portion 309 and the position information transmitting portion 310 in the portable GPS receiving device 100, respectively. Communication is conducted between those portions.

The operation of the above structure according to this embodiment will be described with reference to the accompanying drawings.

(Navigation Information Transmitting Process at Short Distance)

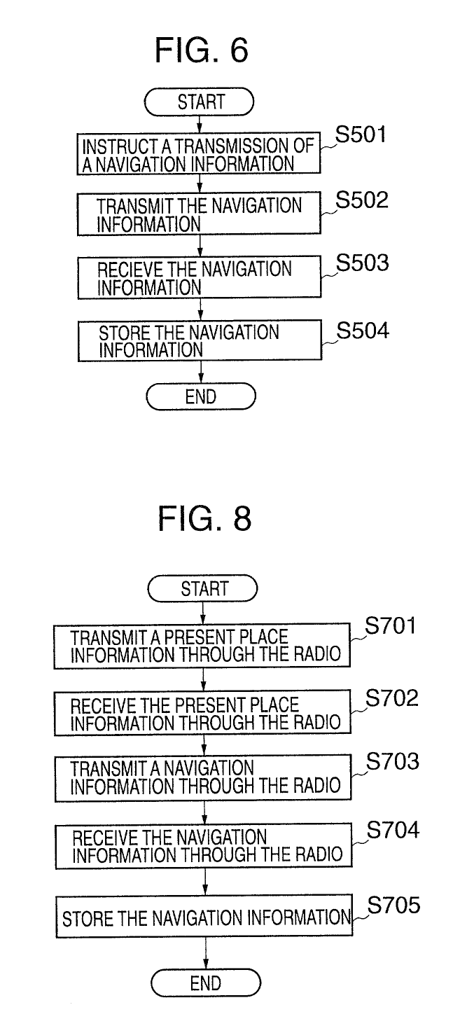

FIG. 6 is a flowchart showing a flow of the navigation information transmitting process (short distance) from the navigation device 200 to the portable GPS receiving device 100 in accordance with this embodiment. In the navigation information transmitting process, first in case of the wire, the user connects the navigation device 200 and the portable GPS receiving device 100 through a cable, and in case of the radio, the navigation device 200 and the portable GPS receiving device 100 are arranged in a communicable positional relation. Then, the user instructs the transmission of the navigation information on the surroundings of the present place to the navigation device 200 through the remote controller 212 (Step S501).

Subsequently, the navigation information transmitting portion 403 of the navigation device 200, which receives the navigation information transmission instruction, transmits the navigation information on the surroundings of the present place to the portable GPS receiving device 100 (Step S502). In this example, the present place may be the present place of the navigation device 200 or the present place of the portable GPS receiving device 100 if the present place information of the portable GPS receiving device 100 is transmitted to the navigation device 200. Then, the navigation information acquiring portion 308 of the portable GPS receiving device 100 acquires the navigation information from the navigation information transmitting portion 403 of the navigation device 200 (Step S503) and then stores the navigation information in the navigation information storage portion 305 (step S504).

(Navigation Process of Portable GPS Receiving Device)

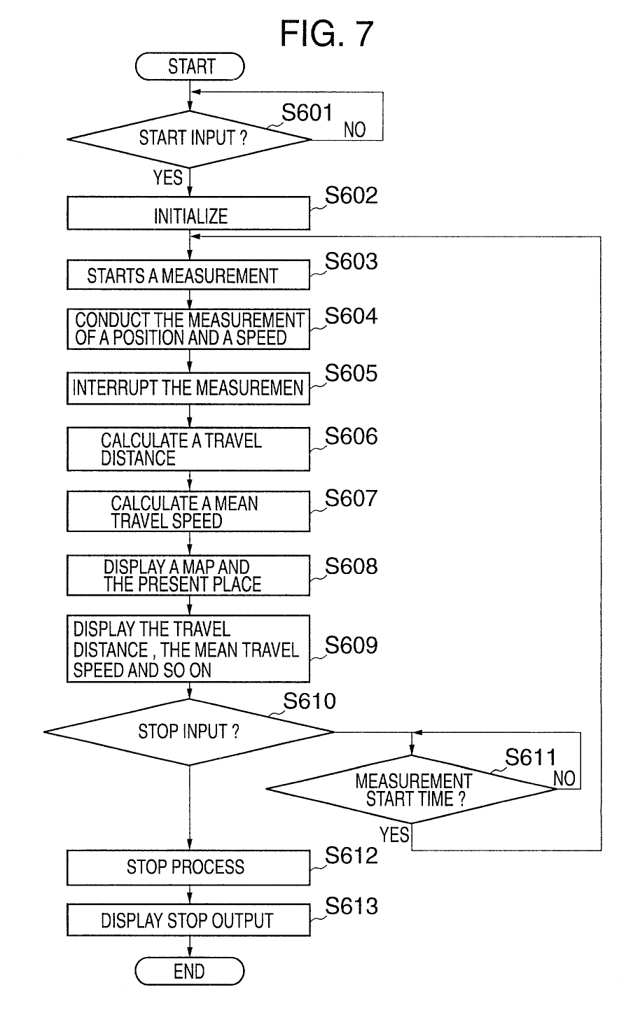

FIG. 7 is a flowchart showing a flow of a navigation process of the portable GPS receiving device 100 in accordance with this embodiment. In the navigation process, when a measurement start input from the user is first detected (yes in Step S601), the navigation portion 301 initializes time count and travel distance data and instructs the measurement start to the measurement portion 306 (Step S602). The measurement portion 306 that receives the command receives GPS electric waves and starts the measurement (Step S603) and conducts the measurement of a position and a speed (Step S604).

Then, the navigation portion 301 instructs the measurement interruption to the measurement portion 306 (Step S605). Then, the travel distance is calculated on the basis of a difference in position data between a start point and the present place (Step S606), and a mean travel speed is calculated on the basis of the travel distance and the elapsed time (Step S607). Also, the navigation portion 301 reads the map information stored in the navigation information storage portion 305 and inputs the present place information from the measurement portion 306 to display the map and the present place on the display (Step S608). The navigation portion 301 scrolls the map display so that the present place can be displayed when the present place is in the outside of the display screen area. Alternatively, the navigation portion 301 may scroll the map display so that the present place is always in the center of the display screen. Also, the calculated travel distance and the mean travel speed are also indicated on the display (Step S609).

Then, the navigation portion 301 judges whether a stop input is made by the user, or not (Step S610). If the stop input is made, the measurement process is completed (Step S612), and the completion of the measurement process is indicated (Step S613). On the other hand, if no stop input is made, the navigation portion 301 waits till a given measurement start time (no in Step S611), and thereafter the operation is advanced to Step S603 (yes in Step S611). For example, the user downloads the map information on the vicinity or the destination information to the portable GPS receiving device 100 at the parking, and travels from the parking to the destination by means of the portable GPS receiving device 100. The portable GPS receiving device 100 can be used for a road guide or outdoor sports regardless of a city or a suburb.

(Navigation Information Transmitting Process at Long Distance)

FIG. 8 is a flowchart showing a flow of the navigation information transmitting process (long distance) from the navigation device 200 to the portable GPS receiving device 100 in accordance with this embodiment. In the navigation information transmitting process, when the user travels out of an area (geometric area) of the navigation information stored in the navigation information storage portion 305, or when the user travels to an end portion of the area of the navigation information, the present place information radio transmitting portion 309 of the portable GPS receiving device 100 transmits the present place information of the portable GPS receiving device 100 to the navigation device 200 through the radio (Step S701). Alternatively, the present place information radio transmitting portion 309 may transmit the present place information of the portable GPS receiving device 100 to the navigation device 200 upon receiving a command from the user.

The present place information radio acquiring portion 406 of the navigation device 200 receives the present place information from the present place information radio transmitting portion 309 of the portable GPS receiving device 100 (Step S702) and outputs the data to the navigation information radio transmitting portion 408. Subsequently, the navigation information radio transmitting portion 408 transmits the navigation information on the surroundings of the present place to the portable GPS receiving device 100 through the radio (Step S703). The navigation information radio acquiring portion 311 of the portable GPS receiving device 100 receives the navigation information from the navigation information radio transmitting portion 408 of the navigation device 200 (Step S704) and stores the navigation information in the navigation information storage portion 305 (Step S705). The wavelength, the intensity, and the like, of electric waves for transmitting and receiving the radio are not particularly restricted.

(Other Navigation Process of Portable GPS Receiving Device)

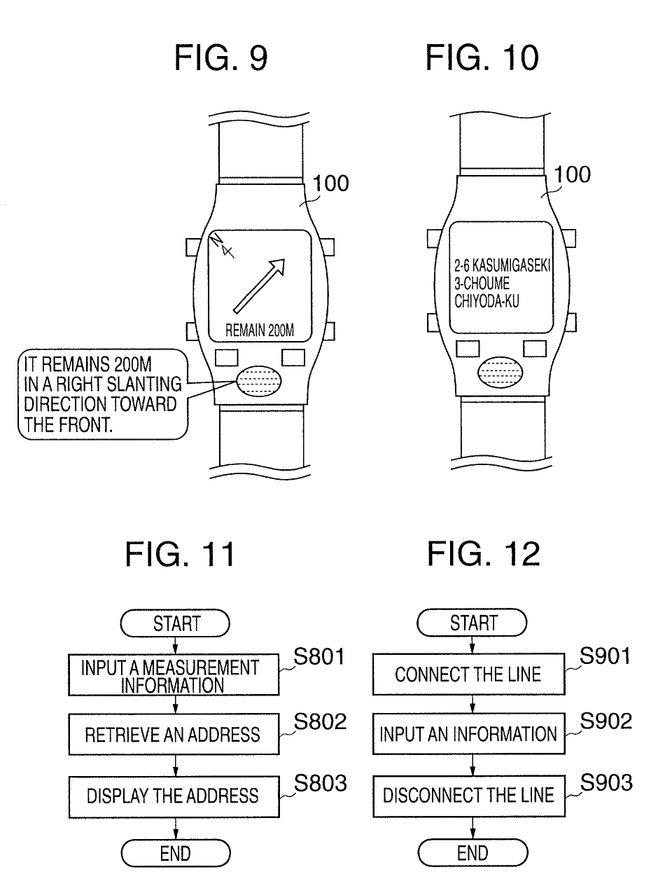

FIG. 9 is an explanatory diagram for explaining another navigation process of the portable GPS receiving device 100 in accordance with this embodiment. For example, in the case where it is difficult to display the map because the display screen of the portable GPS receiving device 100 is small, the navigation portion 301 may indicate the direction of the destination or the distance to the destination by an arrow. Also, the navigation portion 301 may indicate the direction of the destination or the route to the destination by a voice. Further, the navigation portion 301 may indicate the address of the present place as shown in FIG. 10. FIG. 11 is a flowchart showing a flow of the address indicating process of the portable GPS receiving device 100 in accordance with this embodiment.

In the address indicating process, the navigation portion 301 first inputs the present place information from the measurement portion 306 (Step S801). Then, the navigation portion 301 retrieves the address information (ward, city, address No.) from the navigation information storage portion 305 on the basis of the longitude and the latitude of the present place information (Step S802). In this example, the address information of the navigation information storage portion 305, that is, the address information of the CD-ROM is associated with the position information on the longitude and the latitude. Then, the navigation portion 301 indicatest headdress information (Step S803). The fineness of the address information (primary No. or auxiliary No.) can be appropriately set or changed depending on a precision of the measurement.

(Navigation Infomration Supplementing Process)

FIG. 12 is a flowchart showing a flow of the navigation information supplementing process through the radio phone line of the navigation device 200 in accordance with this embodiment. In the navigation information supplementing process, the user first connects the cellular phone mobile device 215 and the navigation device 200 through a cable. Then, the navigation information supplementing portion 401 connects the navigation device 200 to the public line 216 through the cellular phone mobile device 215 (Step S901). The navigation information supplementing portion 401 inputs additional navigation information such as store information (Step S902). Upon completion of that input, the navigation information supplementing portion 401 disconnects the line and completes the process (Step S903).

As described above, according to this embodiment, any one of the map information on the surroundings of the present place of the portable GPS receiving device 100, the destination information, the sightseeing information, the store information, the walking information and other navigation information is transmitted from the navigation device 200 to the portable GPS receiving device 100 through the wire or the radio. With this structure, even if the navigation information on a scheduled place is not previously inputted to the portable GPS receiving device 100 before leaving home by the vehicle such an automobile, the navigation information on the surroundings of a place at which the user has actually gone can be simply and surely inputted to the portable GPS receiving device 100. Therefore, even if the navigation information on the surroundings of the place at which the user has actually gone by the vehicle is not previously inputted to the portable GPS receiving device 100, the portable GPS receiving device 100 can be effectively used.

Also, the present place information radio transmitting portion 309 of the portable GPS receiving device 100 transmits the present place information of the portable GPS receiving device 100 through the radio, and the present place information radio acquiring portion 406 of the navigation device 200 acquires the present place information. Then, the navigation information radio transmitting portion 408 selects the navigation information on the surroundings of the present place on the basis of the present place information from the navigation information storage portion 402 that stores the navigation information therein and transmits the navigation information through the radio, and the navigation information radio acquiring portion 311 of the portable GPS receiving device 100 acquires the navigation information. As a result, because the navigation information on the surroundings of the present place can be appropriately inputted to the portable GPS receiving device 100 with the travel of the user within the limit that the radio electric wave reaches the GPS receiving device 100, even in the case where the user travels out of the scope of the navigation information stored in the portable GPS receiving device 100, the navigation information on the surroundings of the present place is newly inputted to the portable GPS receiving device 100, and the portable GPS receiving device 100 can be effectively used.

Also, the position information storage portion 307 of the portable GPS receiving device 100 stores the position information therein, the position information transmitting portion 310 transmits the position information, and the position information acquiring portion 407 of the navigation device 200 acquires the position information. As a result, for example, it is possible that the position information on a good restaurant, a beauty spot, or a walking locus or other position information which is found while the user walks is recorded, and the position information is transmitted to the navigation device 200 from the portable GPS receiving device 100 in the radio or wire manner.

Also, the portable GPS receiving device 100 includes the address retrieving portion 302 that retrieves the address on the basis of the measured longitude and latitude, the arrow indicating portion 303 that indicates the direction of the destination by an arrow, and the voice guide portion 304 that guides the direction of the destination or the route to the destination with a voice. As a result, even in the case where a display screen is small with the limit of the size of the portable GPS receiving device 100 or the like to make it difficult to view the map indication or to make it impossible to indicate the map, an understandable navigation or position indication can be conducted. Also, since the navigation information supplementing portion 401 of the navigation device 200 supplements the navigation information, rich information can be inputted to the portable GPS receiving device 100.

As is described above, the portable GPS receiving device according to the present invention acquires any one of the map information on the surroundings of the present place of the portable GPS receiving device, the destination information, the sightseeing information, the store information, the walking information and other navigation information from the navigation device. As a result, even if the navigation information on a scheduled place is not previously inputted to the portable GPS receiving device before leaving home by the vehicle such an automobile, the navigation information on the surroundings of a place at which the user has actually gone can be simply and surely inputted to the portable GPS receiving device at the place where the user has actually gone. Therefore, even if the navigation information on the surroundings of the place at which the user has actually gone by the vehicle is not previously inputted to the portable GPS receiving device, the portable GPS receiving device can be effectively used.

Also, in the portable GPS receiving device according to the present invention, the present place information radio transmitting means of the portable GPS receiving device transmits the present place information of the portable GPS receiving device through the radio, and the present place information radio acquiring means acquires the navigation information on the surroundings of the present place from the navigation device through the radio. As a result, because the navigation information on the surroundings of the present place can be appropriately inputted to the portable GPS receiving device with the travel of the user within the limit that the radio electric wave reaches the GPS receiving device, even in the case where the user travels out of the scope of the navigation information stored in the portable GPS receiving device, the navigation information on the surroundings of the present place is newly inputted to the portable GPS receiving device, and the portable GPS receiving device can be effectively used.

Also, in the portable GPS receiving device according to the present invention, the position information storing means stores the position information therein, and the position information transmitting means transmits the position information to the navigation device. As a result, for example, it is possible that the position information on a good restaurant, a beauty spot, a walking locus or the like which is found while the user walks is recorded, and the position information is transmitted to the navigation device from the portable GPS receiving device in the radio or wire manner.

Further, in the portable GPS receiving device according to the present invention, because the address retrieving means retrieves an address on the basis of measured longitude and latitude, even in the case where a display screen is small with the limit of the size of the portable GPS receiving device or the like to make it difficult to view the map indication or to make it impossible to indicate the map, an understandable navigation or position indication can be conducted.

Further, in the portable GPS receiving device according to the present invention, because the destination indicating means indicates a direction of the destination by an arrow, even in the case where a display screen is small with the limit of the size of the portable GPS receiving device or the like to make it difficult to view the map indication or to make it impossible to indicate the map, an understandable navigation or position indication can be conducted.

Still further, in the portable GPS receiving device according to the present invention, because the voice guide means guides the direction of the destination or the route to the destination by a voice, even in the case where a display screen is small with the limit of the size of the portable GPS receiving device or the like to make it difficult to view the map indication or to make it impossible to indicate the map, an understandable navigation or position indication can be conducted.

Yet still further, the navigation device according to the present invention transmits any one of the map information on the surroundings of the present place of the portable GPS receiving device, the destination information, the sightseeing information, the store information, the walking information and other navigation information to the portable GPS receiving device. With this structure, even if the navigation information on a scheduled place is not previously inputted to the portable GPS receiving device before leaving home by the vehicle such an automobile, the navigation information on the surroundings of a place at which the user has actually gone can be simply and surely inputted to the portable GPS receiving device at the place where the user has actually gone. Therefore, even if the navigation information on the surroundings of the place at which the use has actually gone by the vehicle is not previously inputted to the portable GPS receiving device, the portable GPS receiving device can be effectively used.

Yet still further, in the navigation device according to the present invention, the present place information radio acquiring means acquires the present place information of the portable GPS receiving device, and the navigation information radio transmitting means selects the navigation information on the surroundings of the present place on the basis of the present place information from the storage means that stores the navigation information therein and transmits the navigation information through the radio. As a result, because the navigation information on the surroundings of the present place can be appropriately inputted to the portable GPS receiving device with the travel of the user within the limit that the radio electric wave reaches the GPS receiving device, even in the case where the user travels out of the scope of the navigation information stored in the portable GPS receiving device, the navigation information on the surroundings of the present place is newly inputted to the portable GPS receiving device, and the portable GPS receiving device can be effectively used.

Yet still further, in the navigation device according to the present invention, because the position information receiving means acquires the position information from the portable GPS receiving device, for example, it is possible that the position information on a good restaurant, a beauty spot, or a walking locus or other position information which is found while the user walks is recorded, and the position information is transmitted to the navigation device from the portable GPS receiving device in the radio or wire manner.

Yet still further, in the navigation device according to the present invention, because the navigation information supplementing means supplements the navigation information, the rich information can be inputted to the portable GPS receiving device.

Yet still further, the navigation system according to the present invention is comprised of the above GPS receiving device and the above navigation device of the present invention, and has the same effect as that of the above GPS receiving device and the above navigation device according to the present invention.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A portable GPS (Global Positioning System) receiving device comprising:
a storage medium having data storage capacity; and
navigation information acquiring means mounted on a vehicle for acquiring navigation information from a navigation device whose data storage capacity is larger than that of the storage medium, to store the acquired data in the storage medium.

2. A portable GPS receiving device as claimed in claim 1, further comprising present place information radio transmitting means for transmitting the present place information of the portable GPS receiving device to the navigation device mounted on the vehicle through a radio;
wherein the navigation information acquiring means includes navigation information radio acquiring means for acquiring the navigation information on the surroundings of the present place based on the present place information through the radio.

3. A portable GPS receiving device as claimed in claim 1, further comprising position information storing means for storing the position information of the portable GPS receiving device; and
position information transmitting means for transmitting the position information stored in the position information storing means to the navigation device.

4. A portable GPS receiving device as claimed in claim 1, further comprising address retrieving means for retrieving an address on the basis of a measured longitude and latitude.

5. A portable GPS receiving device as claimed in claim l, further comprising arrow indicating means for indicating a direction of a destination by an arrow.

6. A portable GPS receiving device as claimed in claim 1, further comprising voice guide means for guiding the direction of the destination or a route to the destination with a voice.

7. A navigation device mounted on a vehicle comprising:
navigation information transmitting means for selecting the navigation information on the surroundings of the present place of a portable GPS receiving device from storing means for storing navigation information with respect to the portable GPS receiving device which is portable by an user to transmit the selected navigation information.

8. A navigation device as claimed in claim 7, further comprising present place information radio acquiring means for acquiring the present place information of the portable GPS receiving device through a radio;
Wherein the navigation information transmitting means includes navigation information radio transmitting means for selecting the navigation information on the surroundings of the present place based on the present place information from the storing means to transmit the selected navigation information through the radio.

9. A navigation device as claimed in claim 7, further comprising position information acquiring means for acquiring the position information stored in the portable GPS receiving device.

10. A navigation device as claimed in claim 7 further comprising navigation information supplementing means for supplementing additional navigation information through a radio telephone line.

11. A navigation system comprising a portable GPS receiving devices as claimed in claim 1 and a navigation device as claimed in claim 7.
